(19) United States
(12) Patent Application Publication
(10) Pub. No.: US 2015/0008182 A1
(43) Pub. Date: Jan. 8, 2015

(54) PROCESS FOR GARBAGE AND SEWAGE TREATMENT THROUGH A METHOD ABLE TO ACCELERATE THE ANAEROBIC DIGESTION OUTPUT AND PRODUCT RESULTING THEREFROM FURTHER ALLOWING THE USE OF VARYING FEEDSTOCK

(71) Applicant: Christopher J. BARRY, Norwich (GB)

(72) Inventor: Christopher J. BARRY, Norwich (GB)

(73) Assignee: BIOWASTE ENERGY, LDA, Perafita (PT)

(21) Appl. No.: 13/933,261

(22) Filed: Jul. 2, 2013

(51) Int. Cl. C02F 3/28

(52) U.S. Cl. CPC C02F 3/28
USPC 210/606

(57) ABSTRACT

The present invention discloses a system stimulating the increase in efficiency of anaerobic digestion of a plurality of feedstock streams upon stimulation of microbial feedstock ability and methanogen predominance in the digestion microbial mass.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a treatment, for garbage and sewage through a method able to accelerate the anaerobic digestion output and product resulting therefrom further allowing the use of varying feedstock.

2. Description of Related Art Including Information Disclosed Under 37 CFR 1.97 and 37 CFR 1.98.

Biodegradation type apparatuses and drying type apparatuses have been known in the past as raw garbage treatment apparatuses. In the biodegradation system, degradation of organic matter is caused by microorganisms (bio-organisms), and various treatment units of this type have been commercially marketed for general household use. The drying system dehydrates and dries raw garbage by heating and agitating the garbage without relying on microorganisms.

In the case of the biodegradation type system, apparatuses that have a slew degradation rate so that organic matter is slowly and naturally degraded by microorganisms in the natural world are insufficient for practical use, audit is necessary that a continuous degradation of daily raw garbage be done within the same day (within 24 hours). The performance of such an apparatus depends on the capacity of the bio-organisms themselves and on the maintenance of the interior of the treatment tank in an environment that allows efficient activity of the bio-organisms. Accordingly, in order to allow efficient activity of the bio-organisms, the temperature must be controlled (generally to around 60° C.), and appropriate moisture regulation and oxygen (air) supply are also necessary.

In one of the known biodegradation type apparatuses, an organism bed base material (generally called chips), which is porous and in which the regulation of moisture and supply of oxygen, etc. are suited to the activity of the bio-organisms, is employed, and independently developed special chips are used. In the treatment tank that contains the chips, a temperature control device that regulates the temperature to the optimal temperature for the activity of the bio-organisms, a simple-structured agitating apparatus, a fan that supplies oxygen (air), and a sensor of a moisture content monitor are, along with other component, provided. The raw garbage that is placed in the treatment tank is supplied with oxygen and mixed with the chips by being agitated.

In the case of the drying type treatment apparatus, the raw garbage is subjected to a dehydration and, drying treatment by deliberately heating the garbage to a high temperature (to a temperature just prior to the point of carbonization). Accordingly, a heater and a simple agitating apparatus are indeed necessary. Furthermore, since the raw garbage is heated to a high temperature, a strong unpleasant odor is generated. Countermeasures such as air-tight sealing of the treatment tank or the installation of a deodorizing apparatus using a heating catalyst must be, therefore, taken against this odor problem, but this causes the apparatus to he complicated in structure.

Japanese Patent Application Laid-Open (Kokai) No. 59-162957 discloses such a drying type apparatus. In this treatment or disposing apparatus, screw vanes are attached, to the lower part of a rotating shaft that rises from the bottom of the treatment tank, and a cutting mechanism, (cutter) which is formed by rotating blades fastened to the rotating shaft above these screw vanes and fixed blades fastened to the sides of the treatment tank, is provided. The raw garbage that is placed in the treatment tank from above is cut by the cutting mechanism, and the moisture is evaporated on the inside wall of the heated treatment tank. Meanwhile, the cot garbage that falls to the bottom is dried by being caused to contact the walls of the treatment tank while being scraped upward by the screw vanes. The cutter is considered to cut the garbage only once when the raw garbage is introduced.

In the apparatus of Japanese Patent Application Laid-Open (Kokai) No. 2001-113194, a rotating blade is fastened (in a position separated four the bottom) to a rotating shaft that rises from the bottom of the treatment tank, a fixed Made that forms a cutter as a pair with this rotating blade is fastened to the treatment tank, a scraping plate which is fastened to the rotating shaft is provided beneath this cutter. The raw garbage that drops from the cutter is scraped outward in the radial direction and is further scraped upward by a helical inclined plate.

In the case of a biodegradation type raw garbage treatment apparatus, even if the raw garbage consists of organic matter, there may he garbage that hinders the activity of the microorganisms or garbage that requires a long time for degradation, etc. Furthermore, there are also limits to the capacity of the bio-organisms. Accordingly, restrictions and regulations regarding the garbage that can be introduced are also described in the respective handling instructions of various types of raw garbage treatment apparatuses. For example, depending on the type and content of the garbage (e.g., in the case of hard root vegetable scraps, large leaf vegetable scraps, fruit peels, strong fibrous matter, etc.), it may be necessary to put in the garbage after the garbage has been chopped to a size of 3 to 5 cm of less beforehand in order to accelerate degradation. Furthermore, fermented food products, waste edible oils, tobacco, etc. hinder the activity of bio-organisms, while shellfish, the shells of large crustaceans and bones, etc. cannot be degraded in a short period of time, and inorganic material may become mixed in with the garbage. Thus, sufficient attention must be paid to such types of garbage.

Furthermore, in the biodegradation type apparatus, the regulation of moisture is also an important factor for the effective activity of bio-organisms. For the apparatus in commercial use, since the size of the apparatus is large, an automatically controlled water sprinkling system or the like is commonly used for the purpose of moisture regulation. However, in household apparatuses, so as to avoid the apparatus from being complicated and high in price, such a moisture regulation device is ordinarily not provided.

Since excessive moisture has a deleterious effect on the activity of bio-organisms, water must be thoroughly removed from the garbage before the garbage is placed in the apparatus. If the garbage is excessively dried conversely, the bio-organisms will suspend activity. Accordingly, when the amount of moisture is excessive, the introduction of fresh garbage needs to be interrupted until the microorganisms recover their activity or function; while in a dry condition, an appropriate amount of moisture replenishment is required.

When the amount of moisture is excessive, or garbage that contains rice or noodles with a large moisture content or contains a large amount of oil is put in the apparatus, the supply of oxygen is cut off, and degradation becomes difficult (e.g., the chips and garbage form aggregate masses as a result of agitation, etc.), so that chip replacement that is troublesome and requires effort becomes unavoidable. Thus, experience and skill are required in order to use a biodegradation type treatment apparatus in a completely effective manner.

Most of the content of raw garbage is moisture; accordingly, a considerable reduction in volume and weight can be achieved merely by removing this separate moisture content by heating and agitating using a drying type treatment apparatus. In the case of a biodegradation system, it is also an object to reduce die amount of raw garbage by degrading the garbage into carbon dioxide gas and water, etc., by means of microorganisms. In actuality, however, as described above, some garbage cannot be degraded in a short time even if this garbage consists of organic matter, and inorganic matter that cannot be degraded in the first place remains. In cases where the above-described restrictions and regulations regarding the garbage that is placed in the apparatus are not observed, the amount of residue that exists in a rough form is increased even further. Thus, it is actually extremely difficult to smoothly achieve a continuous reduction in the amount of raw garbage.

As described above, the biodegradation system has a problem that a smooth treatment or disposing of the garbage is not continued when the regulation of the moisture content or the type, content, amount, etc. of the raw garbage that is placed in the apparatus are inappropriate (as described above). Thus, an amount of chips that exceeds over the amount actually required is ordinarily placed in the degradation tank beforehand. The amount of chips placed in the tank varies according to the treatment apparatus used but is ordinarily about 15 to 20 liters. One advantage of such a biodegradation system is that the garbage that has been subjected to a degradation treatment can be recycled to be used as fertilizer. In actuality, however, such treated garbage is usually set out as combustible garbage on collection days, and the amount of this combustible garbage increases by the addition of chips. Furthermore, special products must be used for the bio-organisms and chips.

In the drying system, there is no need for complicated control such as moisture control, etc, (as is the casein the biodegradation system); and chips are also unnecessary, and there is no need for experience in the use of the system. However, since the raw garbage is heated to a high temperature, the treatment tank needs to be a heat-resistant vessel that has an agitating apparatus (which also performs pulverization). Moreover, from the standpoint of convenience of use, it is desirable that the treatment tank be detachable. Furthermore, the exhaust gas of the volatilized moisture has a strong odor, so that an airtight apparatus and the installation of a deodorizing device such as a heating catalyst, etc. in the exhaust path are indispensable. As a result, the apparatus becomes complicated.

Raw garbage is placed in the apparatus whenever the garbage is generated (within the disposal capacity for one day) in the biodegradation system; however, in the drying system, when the cover is opened during the disposing process and heating, a strong odor escapes to the outside without passing through the deodorizing device. Accordingly, the next load of garbage must be placed in the apparatus after completing the heat treatment and waiting for the apparatus to cool. Consequently, it is necessary to shorten the treatment time; and it is, therefore, necessary to facilitate heating by reducing the volume of the treatment tank. As a result, the amount of garbage that is put in the treatment tank reduces. Furthermore, the amount of power consumption, which constitutes a running cost, tends to increase.

Furthermore, the apparatus disclosed in Japanese Patent Application Laid-Open (Kokai) No. 59-162957, which is a drying type apparatus, has the above-described problems that are common to drying systems. Moreover, since the cutter of the apparatus only cuts the raw garbage once at a time that the garbage is placed in the apparatus, it is difficult to pulverize the raw garbage to a sufficiently small size. In the ease of the apparatus disclosed in Japanese Patent Application Laid-Open (Kokai) No. 2001-113194, though it appears that the raw garbage can he repeatedly introduced into the cutter while being scraped up by the helical inclined plate; however, since the cutter comprises only a single stage in the axial direction, it takes time to finely cot the raw garbage. Thus, the treatment efficiency is low.

### BRIEF SUMMARY OF THE INVENTION

The present invention discloses a system stimulating the increase in efficiency of anaerobic digestion of a plurality of feedstock streams upon stimulation of microbial feedstock ability and methanogen predominance in the digestion microbial mass.

### DETAILED DESCRIPTION OF THE INVENTION

The present invention relates to a process using specific enzymes at low doses in a given mixture of feedstocks, wherein such enzymes are intended to reduce such mixture to similar molecular forms. It has been found that such molecular forms are able to act as a homogeneous feed source for mutagenesis and other organisms as well when associated thereto (e.g., single sugars, oligosaccharides and fatty acids and derivatives thereof). Moreover, the use of said fermentable forms or oligomers thereof in higher concentrations both stimulates microbial growth and promotes enzyme release, thereby allowing a more ready access to feedstocks by organisms, thus eliminating or at least reducing the need to repeatedly introduce additional enzymes, except if used as restimulating agent or accommodating agent for new feedstocks.

Increasing the availability of sugars in an operating digester leads to a fast rise in volatile fatty acids (VFA). This is due to the use of such released substances by VFA-producing organisms. Such an increase also leads to the production of a higher concentration of matter serving as food for methanogens, and also decreases VFA-producing organism activity, thereby leading to a reduced competitiveness for more complex carbon sources with the methanogenic organisms.

It is then observed an oscillation between the VFA producing activity and methanogenesis. A drop in the VFA production was also observed, thereby enabling both a higher concentration in methane and a higher volume of gas, as the methanogens eventually adapt so as to enter an exponential output. The present process is characterized by operating at mesophilic temperatures and can be carried out in a thermophilic system by reducing the withstanding temperature to upper mesophiles.

By pre-acclimating a methanogenic organism culture to the reactor conditions, enzyme-treating the methanogenic organisms, and then introducing them into the reactor, it is possible to increase both the output and the operational speed.

I claim:

1. A process for garbage and sewage treatment through a method able to accelerate the anaerobic digestion output and product resulting therefrom further allowing the use of varying feedstock comprising:
(a) an operation by mesophilic temperatures that can also be carried out in a thermophilic system by reducing the withstanding temperature to upper mesophiles in order to provide the pre-acclimating methanogenic organism culture to the reactor conditions;
(b) to introduce a methanogenic organism culture to the reactor being possible to increase both the output and the operational speed;
(c) to use of specific enzymes at low doses in a given mixture of feedstocks, wherein such enzymes are intended to reduce such mixture to similar molecular forms that act as a homogeneous feed source for mutagenesis and other organisms as well when associated thereto (e.g., single sugars, oligosaccharides and fatty acids and derivatives thereof);
(d) to use of said fermentable forms or oligomers thereof in higher concentrations both stimulates microbial growth and promotes enzyme release, increasing gas production per feedstock wherein said increase is higher than 60% over a non-treated anaerobic digestion.

2. A process according to claim 1, wherein the ability of using a number of feedstocks and mixtures thereof can be induced.

3. A process according to claim 1, wherein the recovery time from activity decrease due to the new substrate or toxic challenge is reduced from 30 days to less than 10 days, thereby enhancing the overall resilience of the methanogenic culture.
